(19) United States
(12) Patent Application Publication
(10) Pub. No.: US 2022/0114318 A1
(43) Pub. Date: Apr. 14, 2022

(54) METHODS AND APPARATUS FOR IN-FIELD THERMAL CALIBRATION

(71) Applicant: Intel Corporation, Santa Clara, CA (US)

(72) Inventors: Mark Gallina, Hillsboro, OR (US); Jianfang Zhu, Portland, OR (US); Kristoffer Fleming, Chandler, AZ (US); Akhllesh Rallabandi, Chandler, AZ (US); Jianwei Dai, Portland, OR (US)

(21) Appl. No.: 17/557,031

(22) Filed: Dec. 20, 2021

(51) Int. Cl. G06F 30/39; G01K 15/00

(52) U.S. Cl. CPC G06F 30/39; G06F 2119/08; G01K 15/005

(57) ABSTRACT

Methods and apparatus for in-field thermal calibration are disclosed. A disclosed example apparatus includes instructions, memory in the apparatus, and processor circuitry. The processor circuitry is to execute the instructions to determine that a system on chip (SOC) package is deployed, the SOC package deployed with a default first thermal model, in response to the determination that the SOC package is deployed, monitor at least one temperature of the SOC package from a sensor and power usage of the SOC package, calibrate a second thermal model based on the at least one temperature and the power usage, and publish the calibrated second thermal model for control of the SOC package.

### FIELD OF THE DISCLOSURE

This disclosure relates generally to thermal management of computing hardware and, more particularly, to methods and apparatus for in-field thermal calibration.

### BACKGROUND

In recent years, with semiconductor fabrication technology advances, transistor sizes have become relatively smaller. Accordingly, packages as system on chip (SOC) packages have smaller footprints and overall thicknesses. The reduced size of the SOC packages can improve performance and power efficiency, thereby resulting in an improved user experience. However, these advantages can come at a cost of a higher thermal density. In particular, an SOC package can experience a relatively higher rate of temperature change under certain conditions compared to past SOC implementations.

### BRIEF DESCRIPTION OF THE DRAWINGS

FIG. 1 is a schematic overview of an example computing system in which examples disclosed herein can be implemented.

FIG. 2 is a process flow of a known thermal model implementation.

FIG. 3 is an example process flow of a calibrated thermal model implementation in accordance with teachings of this disclosure.

FIG. 4 is a block diagram of an example in-field calibration system in accordance with teachings of this disclosure.

FIGS. 5A-5C depict an example thermal model calibration process that can be implemented in examples disclosed herein.

FIGS. 6-9 are flowcharts representative of example machine readable instructions and/or example operations that may be executed by example processor circuitry to implement the in-field calibration system of FIG. 4.

FIG. 10 is a block diagram of an example processing platform including processor circuitry structured to execute the example machine readable instructions and/or the example operations of FIGS. 6-9 to implement the example in-field calibration system of FIG. 4.

FIG. 11 is a block diagram of an example implementation of the processor circuitry of FIG. 10.

FIG. 12 is a block diagram of another example implementation of the processor circuitry of FIG. 10.

FIG. 13 is a block diagram of an example software distribution platform (e.g., one or more servers) to distribute software (e.g., software corresponding to the example machine readable instructions of FIGS. 6-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Methods and apparatus for in-field thermal calibration are disclosed. Semiconductor packages, such as system on chip (SOC) packages, have become relatively smaller and thinner. However, those advantages come at the cost of a higher thermal density and, as a result, an SOC package could experience a relatively higher rate of temperature change under certain conditions. For example, it has been observed that a temperature rise of 20° C. can occur within a 1 millisecond (ms) window, which is approximately 20 times faster compared to prior SOC implementations.

A relatively high rate of temperature change imposes several implications on an SOC. For example, to ensure functionality and prevent damage thereto, the SOC is typically prevented from allowing its temperature to exceed certain limits, such as a junction temperature limit, for example. To this end, in known systems, a thermal guard band is typically employed in SOC thermal management algorithms. With these thermal guard bands, the SOC can prevent its temperature from going beyond its limits, thereby preventing damage or malfunction of the SOC. However, excessive or conservative limits of a guard band can adversely impact performance due to a lack of utilization of a thermal budget of the SOC. In particular, the limits can result in the SOC limiting its clock frequency more than necessary and, thus, providing relatively less performance. Conversely, the SOC can operate at a frequency that exceeds its thermal budget due to an inaccurate guard band, thereby potentially reducing an operating life thereof.

An additional aspect that is often overlooked with known systems is that thermal performance can diminish over time in the field. In the field, this overall reduction of thermal performance can be caused by a degradation of a thermal interface material positioned/layered between a processor/SOC die and a heat sink, for example. Moreover, fouling and/or clogging of heatsink fins can also result in diminished thermal performance. For instances where the thermal interface material degrades, a transient temperature response of the SOC can be adversely affected. In some known systems, approximately two years of operation can significantly decrease a thermal performance of the SOC and/or hardware associated with the SOC.

Examples disclosed herein enable effective adjustment of thermal settings of an SOC to account for variations in assembly, components, material, assembly and/or tolerances. Examples disclosed herein are able to uniquely characterize individual SOCs and/or associated hardware to accurately control operation of the SOC to individual or specific hardware implementations in the field. Accordingly, examples disclosed herein can more effectively utilize performance capabilities of the SOC by operating the SOC closer to a thermal overhead associated with the specific SOC. In contrast, knowns systems typically utilize a default thermal model that is based on overly conservative thermal characteristics and/or scenarios (e.g., worst-case scenarios). Examples disclosed herein can mitigate and/or adjust to the effects of hardware degradation over an operational life of the SOC.

Examples disclosed herein train a thermal model (e.g., a thermal transient model) of an SOC in three phases: (i) a monitoring phase, (ii) a calibration phase, and (iii) a publishing phase. According to examples disclosed herein, the model is trained to a specific instance, installation, part/component variation and/or assembly of the SOC so that performance of the SOC can be efficiently utilized. In other words, examples disclosed herein tailor performance of an SOC specific to unique and/or individual aspects of the SOC and/or hardware associated with the SOC (e.g., thermal devices, component variation, tolerance stack variation, housing configuration variation, air flow configuration variation, etc.).

Examples disclosed herein determine that a computing device and/or an SOC of the computing device is deployed in the field. According to examples disclosed herein, the SOC is deployed with a default first thermal model (e.g., a default thermal transient model), which includes conservative frequency setpoints. In response to the determination that the SOC is deployed, at least one temperature from a sensor (e.g., an on-die sensor) is monitored and associated with power usage during a time interval. In turn, a second thermal model is calibrated based on the at least one temperature and the power usage. In some examples, the second thermal model is calibrated by replacing and/or substituting data points of the first thermal model. In other words, the second thermal model can be a hybrid of data of the first thermal model (and its associated curves/data) and data obtained from the monitoring phase, for example. Accordingly, the second thermal model can be a modified version of the first thermal model. In some other examples, the second thermal model is generated as a new table or curve based on data points from the aforementioned monitoring phase (e.g., independent of the default first thermal model).

In some examples, the second thermal model is re-trained and/or newly generated after a time duration of the SOC being operated in the field (e.g., to define a third thermal model). In some examples, in addition to replacing some data points from the first thermal model, data points are added to the second thermal model to more accurately characterize the SOC. In some such examples, the data points are added until the second thermal model has converged and/or includes enough data points to approximate thermal transient characteristics of the computing device with a requisite degree of accuracy. In some examples, the sensor includes an on-die sensor of the SOC. In some such examples, the on-die sensor is associated with a computing unit (e.g., a core) of the SOC.

As used herein, the term “thermal model” refers to data that reflects assumed or measured thermal parameters and/or behavior associated with a device, component, assembly and/or system. Accordingly, the term “thermal model” can refer to a table, an array, a curve, an equation, etc. As used herein, the term “field” refers to an environment at which a computing device is to be operated during its operational life. Accordingly, the term “field” can refer to consumer and/or commercial use, for example, of the computing device as the computing device is used during its operational life. As used herein, the term “deployed” refers to a device and/or system being utilized during its operational life. As used herein, stating that a first object or item is “unitary” with a second object or item means that the first object is at least a source for the second object. Accordingly, stating that the first object is “unitary” with the second object does not necessitate that the first object and the second object are always identical (e.g., the second object can be a modified or updated version of the first object and vice-versa).

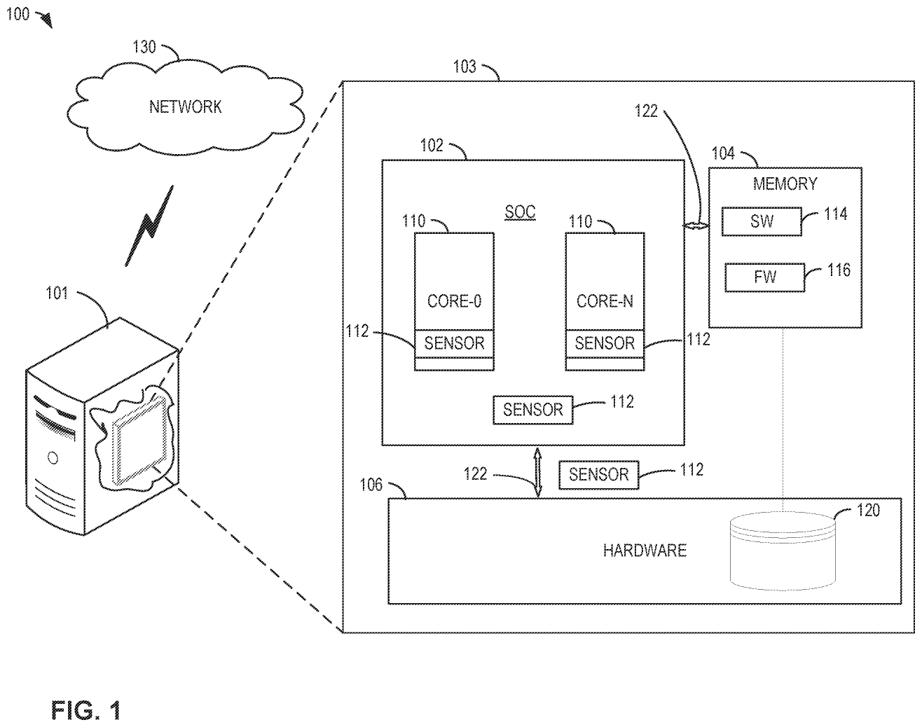

FIG. 1 is a schematic illustration of an example computing system 100 in which examples disclosed herein can be implemented. In the illustrated example of FIG. 1, the computing system 100 includes a computing device (e.g., a circuit board, a motherboard, a computer, a mobile device, a tablet, a PC, a laptop, an appliance, a network device, etc.) 101, which, in turn, includes an SOC (e.g., an SOC package, an SOC processor, an SOC memory controller, an SOC cache controller, etc.) 102 that is mounted and electrically coupled to a motherboard 103. In this example, the SOC 102 is electrically and/or communicatively coupled to memory 104, which is implemented as random access memory (RAM) in this example, as well as devices 106 (e.g., hardware devices, functional devices, computing devices, peripheral devices, etc.).

In this example, the SOC 102 includes multiple functional computing units 110, which are implemented as processor cores (e.g., logical cores, processing cores, compute cores, computing cores, etc.) in this example, and may include sensors (e.g., on-die sensors) 112. The sensors 112 can be associated with the SOC 102, at least one of the computing units 110, the motherboard 103 and/or any appropriate associated hardware of the computing device 101. In examples disclosed herein, the computing units 110 are further referred to as cores 110 for clarity. However, the computing units 110 do not necessarily have to be implemented by cores. For example, the computing units could be implemented by logical performance units of cache, memory, a bus controller, etc. In this example, the memory 104 is utilized for executing at least one thread of software 114 and/or firmware 116 by the SOC 102. The software 114 and/or the firmware 116 can be stored in a storage 120 of the devices 106. The devices 106 can include hardware and/or peripherals associated with and/or included by the computing device 101. In this example, interfaces 122 communicatively coupled the SOC 102 to the devices 106 and the memory 104.

To accurately control a frequency and/or performance of the example SOC 102, examples disclosed herein implement a calibrated thermal model to adjust operation and/or control of the SOC 102. In particular, a thermal model (e.g., a thermal transient model) that corresponds to specific characteristics of the individual SOC 102 is calibrated to account for numerous parameters including, but not limited to, SOC performance variation, SOC component variation, processing variation, dimensional/size variation, cooling component differences, cooling configurations, computing device aspects, etc. This calibrated model can be based on a default thermal model that is initially used for control of the SOC 102. Upon calibration of the calibrated thermal model, the default thermal model is no longer utilized and a frequency of the SOC 102 and/or least one of the cores 110 is controlled based on the calibrated thermal model.

In the illustrated example of FIG. 1, to calibrate the thermal model in response to determining that the SOC 102 and/or the computing device 101 is deployed in the field (e.g., the SOC 102 is being utilized in an operational life thereof), thermal performance (e.g., temperature) of the SOC 102 is monitored to gather data (e.g., data points). In particular, temperatures are measured and associated power usage is determined and/or calculated to generate data points and, in turn, calibrate the thermal model. The monitoring and/or calibration of the thermal model can be active or passive. For examples with active monitoring and/or calibration, known or pre-defined workloads are assigned to the SOC 102 in order to monitor temperature in combination with power usage. Conversely, for examples with passive monitoring and/or calibration, workloads associated with operational use of the SOC 102 are assigned to the SOC 102 (e.g., typical user workloads during the operational life of the SOC 102).

In this example, when calibration of the thermal model is completed, the calibrated thermal model is published for use by the SOC 102. In the illustrated example, the calibrated thermal model is published by replacing the default calibrated thermal model originally provided with the SOC 102 and/or the computing device 101 with the calibrated thermal model in operation. As a result, the SOC 102 is controlled with a thermal guard band that is relatively more accurate to individual conditions, variations and/or tolerances thereof. In other words, the example SOC 102 is operated and/or controlled based on individualized thermal parameters, performance and/or conditions.

In some examples, the computing device 101 is communicatively coupled to and/or part of a network 130. In some such examples, the calibrated thermal model can be transferred from the computing device 101 (e.g., for subsequent development and/or reiteration of further default thermal models). Additionally or alternatively, software that directs the computing device 101 to calibrate and/or generate thermal models is received at the computing device 101 from the network 130. However, any other appropriate computing and/or network topology can be implemented instead.

While the cores 110 are implemented as processor cores in this example, the cores 110 can be implemented as individual computing units of memory (e.g., random access memory, cache memory, a network controller, etc.), a device controller (e.g., a hard disk controller, a memory controller, a cache controller, etc.) or any other appropriate device that manages performance of discrete and/or individual computing units. In other words, examples disclosed herein are not solely limited to SOCs and/or SOC packages.

While the example of FIG. 1 shown in the context of a computing device 101, which is implemented as a personal computer in this example, examples disclosed herein can be implemented with any other type of computing device, such as a tablet, a laptop computer, a mobile device, a mobile phone, a console, a network device, a media device, peripheral device and/or a device controller, etc. Further, examples disclosed herein can be implemented in computing systems, such as networks or cloud-based systems, for example. As mentioned above, example disclosed herein can be implemented in any appropriate computing and/or network topology.

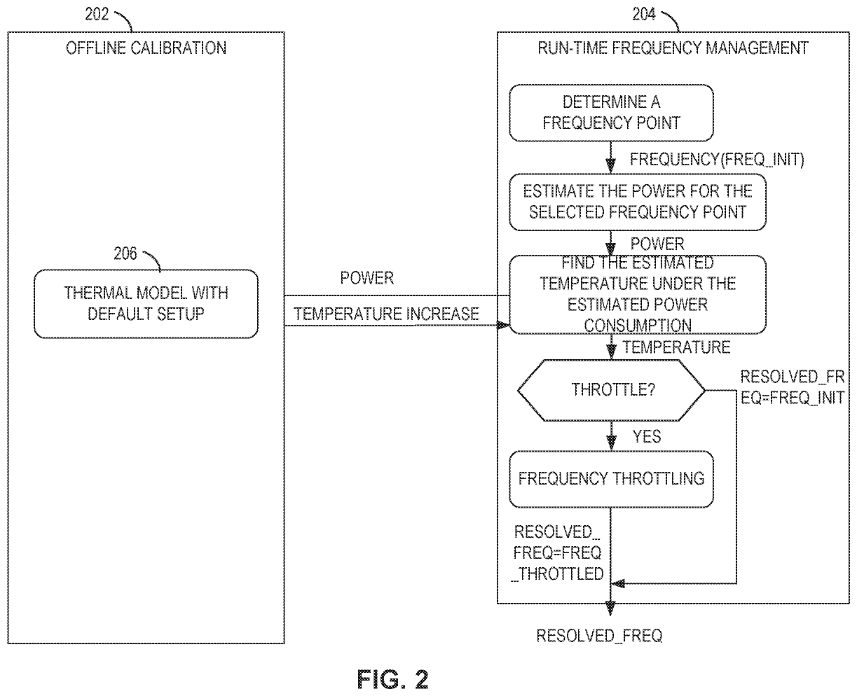

FIG. 2 is a process flow of a known thermal model implementation. In this known implementation, an offline calibration stage 202 and a run-time frequency management stage 204 are shown. The offline calibration stage 202 corresponds to an initial setup of an SOC while the run-time frequency management stage 204 corresponds to an operational phase (e.g., in-service phase) of the SOC.

In operation, during the aforementioned run-time frequency management stage 204, a frequency setpoint and/or setting of the SOC is determined. In turn, a power corresponding to the frequency setpoint is estimated. Further, a temperature and/or temperature change (e.g., a temperature delta) corresponding to the aforementioned power is determined, estimated based on a default thermal model 206 having a default thermal characterization. In particular, the power is utilized to estimate the temperature based on the power. The estimated temperature is, in turn, used to determine whether to throttle the SOC. If the SOC is to be throttled, the SOC is operated at a resolved frequency that is throttled from an initial frequency. If the SOC is not to be throttled, the resolved frequency is equal to the initial frequency. In contrast to examples disclosed herein, use of the default thermal model 206 often results in overly conservative operation and/or frequency control of the SOC such that the SOC is prevented from reaching its full potential. In particular, the default thermal model 206 often corresponds to a worst-case scenario for the SOC (e.g., a worst-case scenario for cooling, hardware differences, anticipated degradation, etc.).

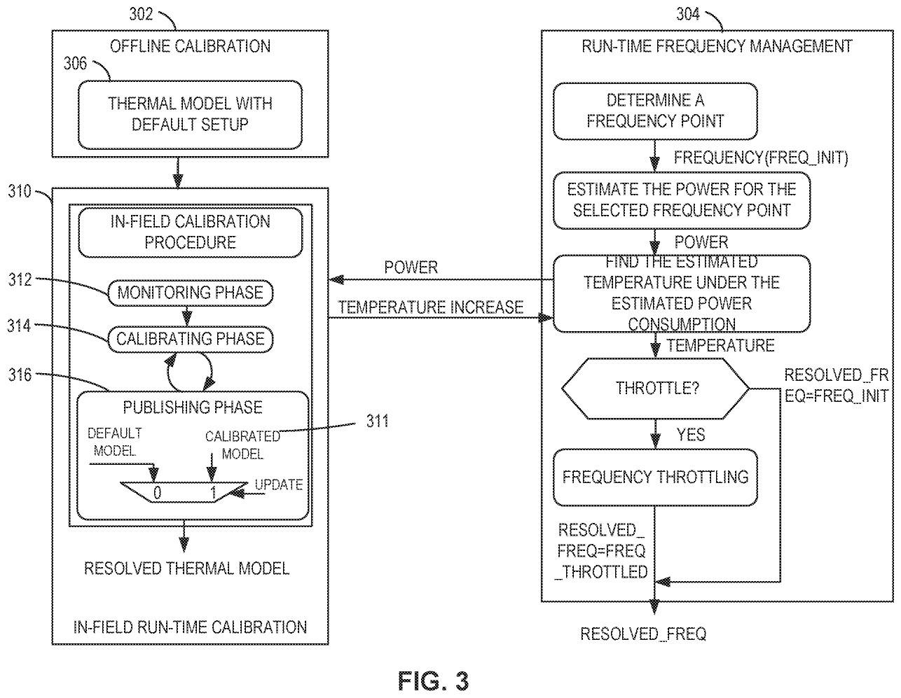

FIG. 3 is an example process flow of a calibrated thermal model in accordance with teachings of this disclosure. In the illustrated example of FIG. 3, an offline calibration stage 302, and a run-time frequency management stage 304 are shown, and a default first thermal model 306 corresponds to the offline calibration stage 302. Further, an in-field calibration 310 is depicted in FIG. 3 as interposed between the offline calibration stage 302 and the run-time frequency management stage 304. The offline calibration stage 302 corresponds to a default/initial setup of the SOC 102 while the run-time frequency management stage 304 corresponds to an operational phase of the SOC 102 (e.g., the SOC 102 is deployed in the field). In contrast to the known system of FIG. 2, the default first thermal model 306 is only initially utilized in the run-time frequency management stage 304 and an updated or newer calibrated second thermal model 311 is subsequently provided to the run-time frequency management stage 304 once the second thermal model is sufficiently and/or fully calibrated/developed/converged. At least a portion (e.g., certain data points) of the example second thermal model 311 may be represented by and/or based on equation (1) below:

deltaT=Pactual*(Tf−Ts)/Peval (1)

where Tf: Final temperature during the evaluation window, Ts: Starting temperature during a time interval or evaluation window, Peval: Power input during the evaluation window, Pactual: power increase during a runtime window, and deltaT: Predicted temperature change during the evaluation window.

To collect data points (during monitoring) required for calibration and/or generation of the second thermal model 311, the sensor 112 of FIG. 1 can be implemented as an on-die monitor, for example. In such examples, the on-die monitor can obtain a requisite amount of data points periodically or on-demand and provide the data for calibration of the second thermal model 311. A corresponding sampling rate can be design dependent according to features of the SOC 102. For example, a sampling rate of the on-die monitor may be once per 1 ms. In examples where on-die current sensing circuitry is available, the on-die monitor can sample current consumption via the on-die current sensing circuit and multiply the current with voltage to derive a power consumption. While, in other systems in which an on-die current sensing circuit is not available, the on-die monitor can utilize a digital power meter to estimate power consumption, for example.

According to the illustrated example of FIG. 3, the in-field calibration 310 includes a monitoring phase 312, a calibration phase 314 and a publishing phase 316. During the example monitoring phase 312, operation of the SOC 102 is monitored such that data points corresponding to temperatures with corresponding power usage of the SOC 102 are obtained. In turn, during the calibration phase 314, the second thermal model 311 (or the first thermal model 306) is calibrated to be more individualized and, thus, more accurate in terms of the specific installation and/or implementation of the SOC 102. In some examples, the second thermal model 311 is an adjusted and/or revised version of the first thermal model 306. In other examples, the second thermal model is newly generated. Once the calibrated second thermal model is available (e.g., enough data points have been obtained, a calibration curve is not significantly changing with additional data points added, etc.), in the example publishing phase 316, the second thermal model is, in turn, provided to the run-time frequency management stage 304 as a resolved thermal model to be utilized in estimating a temperature rise/increase based on an estimated power. However, the second thermal model can output any other appropriate parameter or be provided with a different appropriate input from the estimated power.

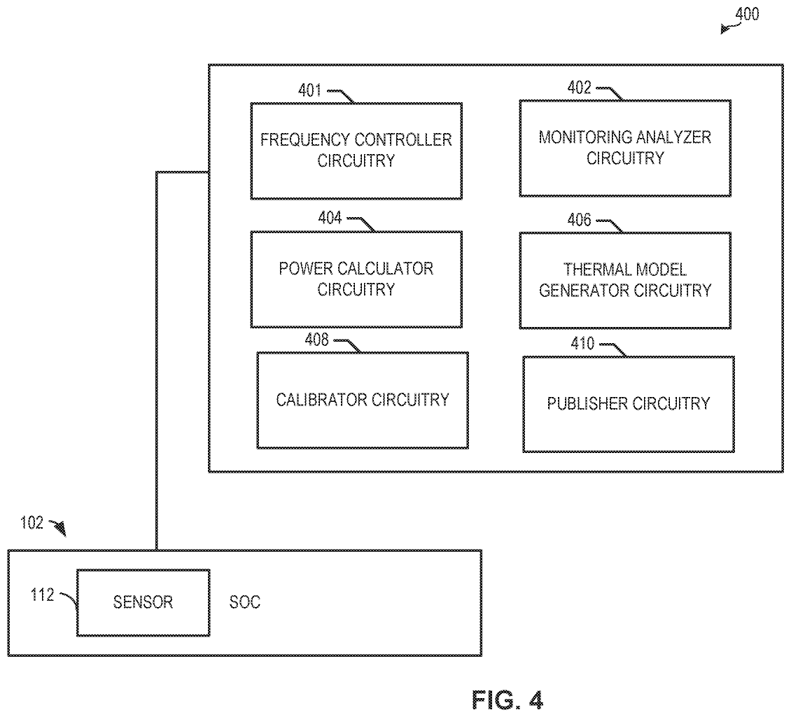

FIG. 4 is a block diagram of an in-field calibration system 400 to calibrate a thermal model to control the computing device 101 deployed in the field. The in-field calibration system 400 of FIG. 4 may be instantiated (e.g., creating an instance of, bring into being for any length of time, materialize, implement, etc.) by processor circuitry such as a central processing unit executing instructions. Additionally or alternatively, the in-field calibration system 400 of FIG. 4 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 4 may, thus, be instantiated at the same or different times. Some or all of the circuitry may be instantiated, for example, in one or more threads executing concurrently on hardware and/or in series on hardware. Moreover, in some examples, some or all of the circuitry of FIG. 4 may be implemented by one or more virtual machines and/or containers executing on the microprocessor.

The in-field calibration system 400 of the illustrated example includes example frequency controller circuitry 401, example monitoring analyzer circuitry 402, example power calculator circuitry 404, example thermal model generator circuitry 406, example calibrator circuitry 408 and example publisher circuitry 410. In the illustrated example, the field calibration system 400 is implemented by and/or is communicatively coupled to the SOC 102 and/or the sensor 112 of the computing device 101 shown in FIG. 1.

The example frequency controller circuitry 401 is implemented to control a frequency of the SOC 102 and/or at least one of the cores 110 based on a thermal calibration model. In the illustrated example, the frequency controller circuitry 401 controls the frequency with a default first thermal model until a second thermal model, which may be unitary with the first thermal model, is calibrated and published. In some examples, the frequency controller 401 selects a frequency of the SOC 102 from a table and/or an array, for example.

In the illustrated example of FIG. 4, the monitoring analyzer circuitry 402 is implemented to monitor the SOC 102 and/or at least one of the cores 110 in response to determining that the computing device 101 and/or the SOC 102 have been deployed to the field. In this example, the monitoring analyzer circuitry 402 collects data points, each corresponding to a power (e.g., an estimated power) and a respective measured temperature measured from at least one of the sensors 112. However, the data points can correspond to any other appropriate parameters including, but not limited to, internal ambient temperature, core utilization, SOC cooling system capacity, etc.

The example power calculator circuitry 404 calculates and/or estimates an estimated power usage of the SOC 102. In particular, the power calculator circuitry 404 calculates and/or estimates the power usage based on a current draw of the SOC 102 in combination with a voltage associated with the SOC 102. However, any other appropriate measurement or calculation of the power can be implemented instead. In this example, the power calculated by the power calculator circuitry 404 is utilized as an input for a thermal model in use (i.e., either a default thermal model, a partially calibrated thermal model or a fully calibrated thermal model).

In some examples, the thermal model generator circuitry 406 of the illustrated example generates the second thermal model based on data points obtained from monitoring the SOC 102 with the example monitoring analyzer circuitry 402. In some such examples, the second thermal model is fully generated by the thermal model generator circuitry 406 and can be represented by a curve that relates temperature (e.g., a temperature increase, a temperature delta, etc.) to power and/or current. In other words, the second thermal model can be fully generated independent of the first thermal model, in some examples.

In this example, the calibrator circuitry 408 calibrates and/or develops the second thermal model (e.g., as a curve or table associated with the aforementioned data points). The example calibrator circuitry 408 can adjust and/or revise at least one data point of the first thermal model based on monitoring of the SOC 102 to yield the second thermal model. In particular examples, the calibrator circuitry 408 adds and/or replaces data points of the first thermal model with data points form monitoring the SOC 102. In other words, the second thermal model is generated by adding, replacing and/or substituting points pertaining to the default first thermal model, thereby defining a hybrid of the original data points and updated/newer data points obtained from monitoring the SOC, for example. In some examples, the calibrator circuitry 408 determines whether the second thermal model is ready (e.g., fully calibrated, converged, etc.) for in-field operation and, thus, publishing for that purpose. In some examples, the second thermal model is continuously updated (e.g., data points are constantly revised and/or added during in-field operation of the SOC 102) by the calibrator circuitry 408. In some such examples, the second thermal model is utilized by the SOC 102 while being partially calibrated (e.g., the second thermal model is partially calibrated version of the first thermal model).

The example publisher circuitry 410 publishes and/or enables utilization of the calibrated second thermal model by the SOC 102 and/or at least one of the cores 110. The publication may occur in response to the determination that the second thermal model is ready for utilization by the SOC 102. In some examples, the publisher circuitry 410 determines whether an updated or newer thermal model (e.g., a third thermal model) is necessitated (e.g., during an in-field operational life of the computing device 101). This determination may be based on whether the second thermal model has sufficient convergence, whether sufficient data points are obtained for calibration of the second thermal model, whether an elapsed time in the field has occurred (e.g., six months to two years after an initial field deployment of the computing device 101), a significant shift in thermal performance of the computing device 101 and/or the SOC 102 has been initiated, etc.

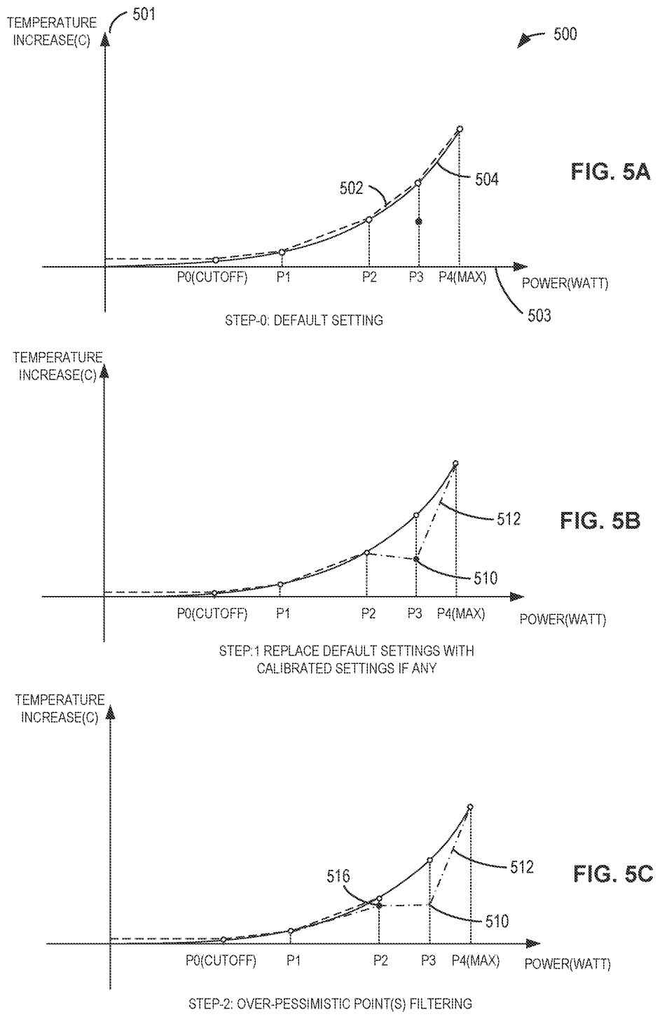

FIGS. 5A-5C depict an example thermal model calibration process that can be implemented in examples disclosed herein. Turning to FIG. 5A, a plot 500 is shown with a vertical axis 501 representing a temperature increase while a horizontal axis 503 represents power/power usage in watts. In the illustrated example of FIG. 5A, a curve 502 represents data points of the default first thermal model while a curve 504 represents a fitted equation corresponding to the data points of the curve 502.

As can be seen in this example, a set of discrete points approximates an actual curve represented by the equation (1) mentioned above in connection with FIG. 3. The number of discrete points can be design dependent. In this specific example, five discrete points span from P0 to P4. Because of the variation before P0 is relatively small, to simplify calibration, in some examples, P0 from the default thermal model is utilized and, thus, will not be calibrated. Therefore, P1 to P4 are subjected to run-time calibration, for example.

Turning to FIG. 5B, adjustment and/or calibration is shown after monitoring. In this example, a calibrated/adjusted data point 510 is shown along with an adjusted/calibrated curve 512, which is different from the curve 504 shown in FIG. 5A. In the illustrated example of FIG. 5B, only P3 is calibrated. As can be seen in FIG. 5B, the default first thermal model can be calibrated by replacing/updating/adding data points thereof to define the calibrated second thermal model, for example.

According to examples disclosed herein, for monitoring (and to obtain data points for calibration), there are two approaches for data collection: an active approach, and a passive approach. In the active approach, software provides identified workloads (e.g., sufficient to cover desired data points periodically during the calibration phase, workloads designed only to cause the SOC 102 to operate without any usable program output), for example. In some examples, performance of the workload will be repeated multiple times to account for errors and/or variation (e.g., run to run errors).

In the aforementioned example passive approach, an on-die monitor or sensor samples data during normal/routine operation (e.g., user-directed control). Accordingly, this example approach can have a dependency on actual system operation to finalize values of each of those discrete points. Accordingly, some of the discrete points may not be calibrated specifically.

Turning to FIG. 5C, the curve 512 is shown calibrated with the data point 510, as well as an additional adjusted data point 516. Accordingly, the curve 512 is updated. In some examples, an equation is fit (e.g., polynomial fit) for utilization of the curve 512 as the calibrated second thermal model. Additionally or alternatively, interpolation is utilized between the data points of the curve 512, for example.

In some examples, to ensure a relatively high quality and accurate calibration of the second thermal model, and eliminate impacts from run-to-run error, in some examples, for each data point, there is a minimum/requisite number of samples that need to be evaluated prior to completion of calibration for each of the data points. In other words, multiple samples for each data point can improve an accuracy of the second thermal model.

In this example, calibration of each of the discrete data points shown in FIG. 5C is finalized. Accordingly, the entire curve 512 is updated based on the finalized discrete data points. As mentioned above, all defined discrete data points may not be analyzed and/or adjusted during calibration process due to the lack of representative data collected from the monitoring phase, especially when a passive approach is adopted for calibrating the second thermal model. Therefore, the example curve 512 can be updated based on calibrated data points.

An example approach depicted in the following pseudo code is proposed in examples disclosed herein:

INPUTS:
* default setting: P_DEFAULT[4:0]
*calibrated setting:P_CALIBRATED[4:0]

*P_CALIBRATED[4:0] 0: not_calibrated non-zero: calibrated

//step-1: replace the default setting with calibrated settings
for (i=0; i<N; i++) {

if P_CALIBRATED[i]!=0 {
P_TEMP[i] = P_CALIBRATED[i]
} else {
P_TEMP[i] = P_DEFAULT[i]
}

}
//step -2: re-build the curve
P_RESOLVED[N−1] = P_TEMP[N−1]
For (i=N−2; i<=0; i−−) {

If (P_TEMP[i] > P_TEMP[i+1]) {
P_RESOLVED[i] = P_TEMP[i+1]
}

}

In this example, there are two steps. In a first example step, default settings are replaced with the calibrated settings, if applicable (e.g., the data point is calibrated). In the second example step, over-pessimistic data points are filtered out due to being uncalibrated. This filtering can occur during calibration when there is insufficient data to calibrate each data point and, hence, some data points remain at their default values (e.g., originally provided values with the first thermal model), for example. Given the default values are often related to a predicted worst case scenario, for example, it is probable that some default values are greater than what their true actual values. This can lead to instances where some data points have a greater value than a value of a data point on its right. Given an assumption that the curve should increase monotonically as power increases, the over-pessimistic points may be replaced with the values from adjacent greater value data points, as shown in the example step-2 of the pseudo code above.

Once the second thermal model is calibrated, as shown in FIG. 5C, run-time frequency management algorithms can utilize the second thermal model to predict the temperature rise for a given power consumption at run-time and, in turn, determine whether to throttle the SOC 102 or not.

While an example manner of implementing the in-field calibration system 400 of FIG. 4 is illustrated in FIG. 4, one or more of the elements, processes, and/or devices illustrated in FIG. 4 may be combined, divided, re-arranged, omitted, eliminated, and/or implemented in any other way. Further, the example frequency controller circuitry 401, the example monitoring analyzer circuitry 402, the example power calculator circuitry 404, the example thermal model generator circuitry 406, the example calibrator circuitry 408, the example publisher circuitry 410, and/or, more generally, the example in-field calibration system 400 of FIG. 4, may be implemented by hardware alone or by hardware in combination with software and/or firmware. Thus, for example, any of the example frequency controller circuitry 401, the example monitoring analyzer circuitry 402, the example power calculator circuitry 404, the example thermal model generator circuitry 406, the example calibrator circuitry 408, the example publisher circuitry 410, and/or, more generally, the example in-field calibration system 400, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example in-field calibration system 400 of FIG. 4 may include one or more elements, processes, and/or devices in addition to, or instead of, those illustrated in FIG. 4, and/or may include more than one of any or all of the illustrated elements, processes and devices.

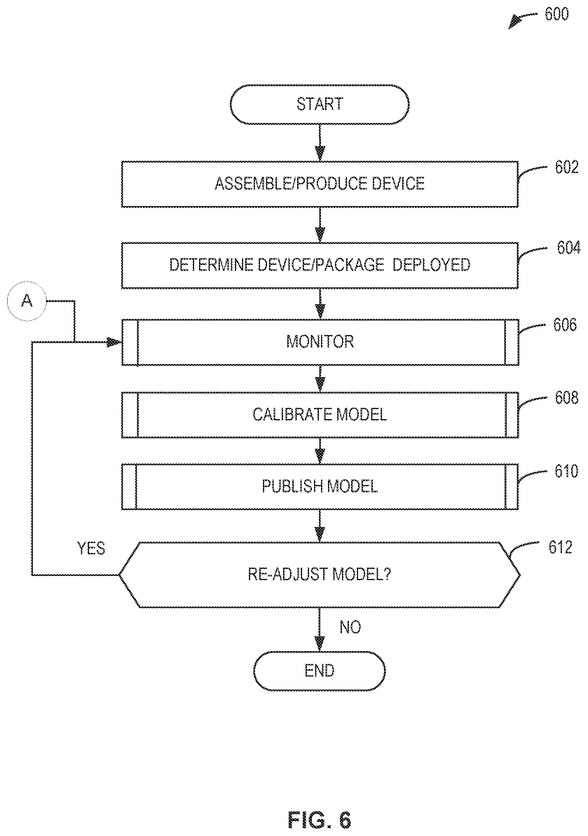

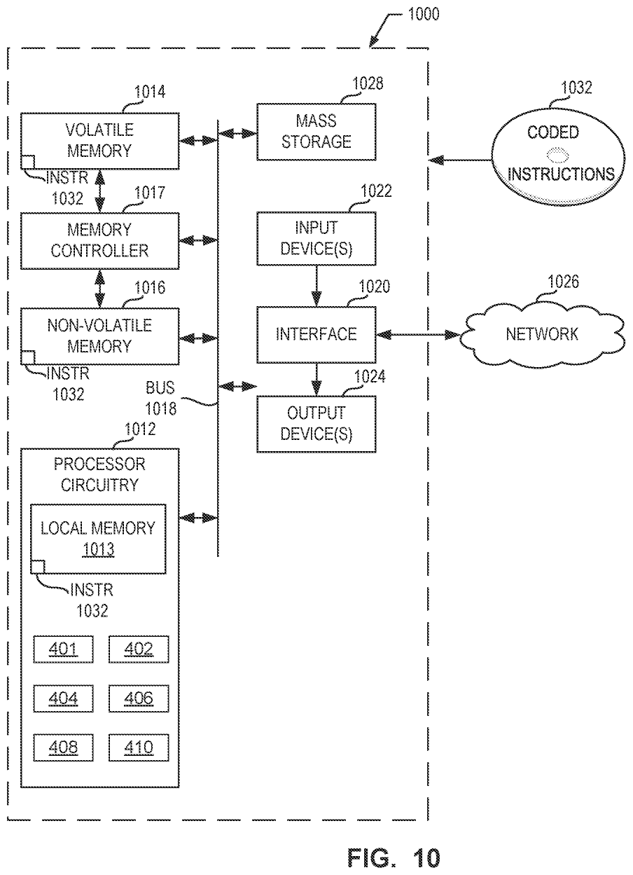

Flowcharts representative of example hardware logic circuitry, machine readable instructions, hardware implemented state machines, and/or any combination thereof for implementing the in-field calibration system 400 of FIG. 4 are shown in FIGS. 6-9. The machine readable instructions may be one or more executable programs or portion(s) of an executable program for execution by processor circuitry, such as the processor circuitry 1012 shown in the example processor platform 1000 discussed below in connection with FIG. 10 and/or the example processor circuitry discussed below in connection with FIGS. 10 and/or 11. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 3, many other methods of implementing the example in-field calibration system 400 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-9 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by processor circuitry to calibrate a thermal model for specific individual hardware and/or an implementation thereof. The machine readable instructions and/or the operations 600 of FIG. 6 begin at block 602, at which the computing device 101 is produced and/or assembled. In this example, the computing device 101 is produced, pre-programmed and/or assembled with a default first thermal model that corresponds to a conservative thermal parameters to be used in controlling at least one aspect of the SOC 102, such as a frequency thereof, for example.

At block 604, the example monitoring analyzer circuitry 402 determines whether the SOC 102 and/or the computing device 101 is deployed in the field. In some examples, this determination is based on whether user applications are being run and/or whether a user has indicated that the computing device 101 is in the field (e.g., whether the computing device 101 has entered an operational phase). In some examples, the monitoring analyzer circuitry 402 determines that the computing device 101 and/or the SOC 102 is deployed when the computing device 101 is first turn on in the field subsequent to production.

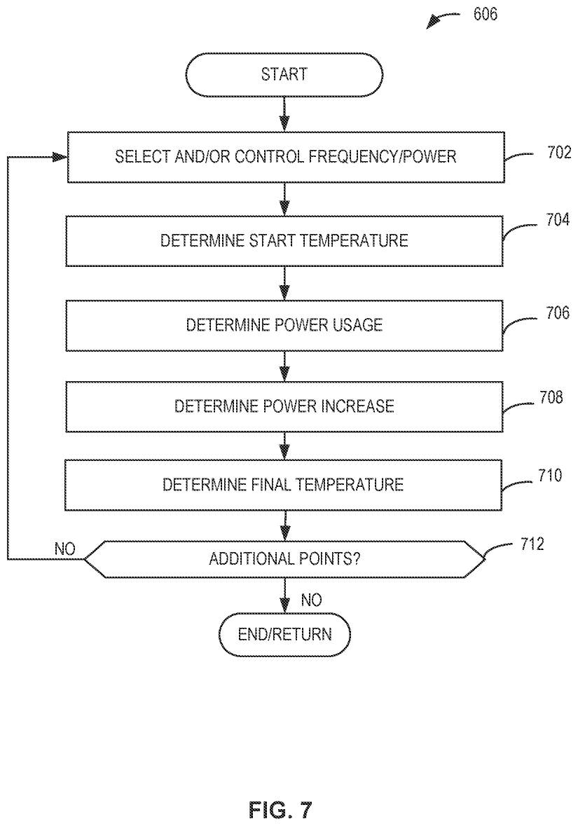

In the illustrated example of FIG. 6, at block 606, as will be discussed in greater detail below in connection with FIG. 7, the monitoring analyzer circuitry 402 monitors operation of the SOC 102 while executing workloads in the field. In this example, the monitoring analyzer circuitry 402 determines at least one temperature of the SOC 102 via the sensor 112, which is implemented as an on-die temperature sensor in this example, and power corresponding to the at least one temperature of the SOC 102. In particular, data points each having a measured temperature and a corresponding power are plotted onto a chart, table, array or graph, for example.

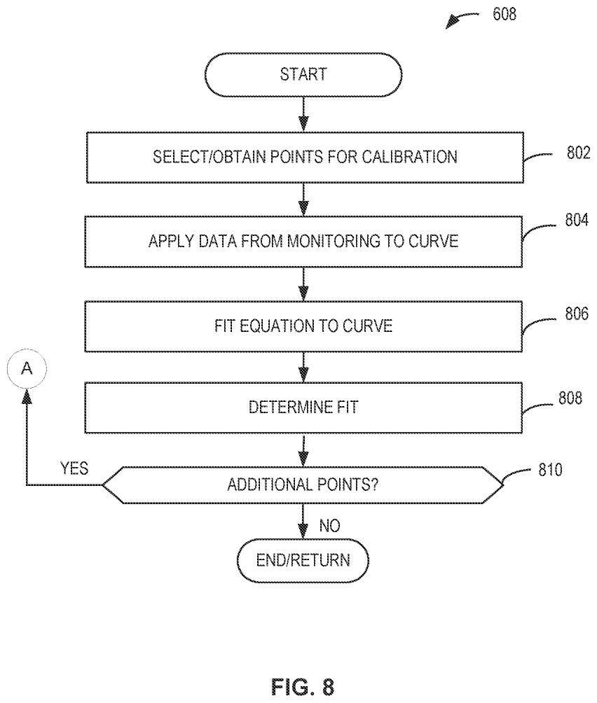

At block 608, as will be discussed in greater detail below in connection with FIG. 8, the calibrator circuitry 408 calibrates a thermal model. In this example, the calibrator circuitry 408 adds, removes, replaces and/or deletes data points of the first thermal model to define a second thermal model. In some examples, the calibrator circuitry 408 initiates calibration of the second thermal model based on obtaining a requisite number of data points monitoring the SOC 102.

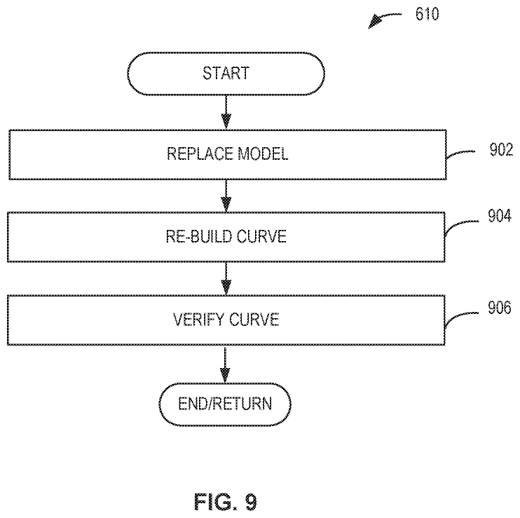

At block 610, as will be discussed in greater detail below in connection with FIG. 9, the publisher circuitry 410 publishes the second thermal model. In the illustrated example of FIG. 6, the publisher circuitry 410 publishes the second thermal model for use in controlling the SOC 102 by replacing the first thermal model with the second thermal model (e.g., while the first thermal model is being implemented).

At block 612, in some examples, the calibrator circuitry 408 and/or the publisher circuitry 410 determines whether to re-adjust the second thermal model. If the second thermal model is to be re-adjusted (block 612), control of the process returns to block 606. Otherwise, the process ends. The determination can be based on whether the computing device 101 has been operated for a requisite amount of time, whether thermal properties and/or performance of the computing device 101 and/or the SOC 102 has changed significantly.

FIG. 7 is a flowchart representative of an example subroutine 606 of the example machine readable instructions and/or example operations 600 of FIG. 6.

At block 702, the frequency controller 401 and/or the example power calculator circuitry 702 controls a frequency and/or a power setting of the SOC 102 and/or at least one of the cores 110. In some examples, the frequency setting is based on a pre-designated workload that operates the SOC 102 at frequency ranges intended to provide a sufficient range of data points associated with the SOC 102 corresponding to numerous different frequencies and/or frequency settings.

At block 704, the example monitoring analyzer circuitry 402 determines and/or measures a beginning or start temperature of the SOC 102 and/or the core 110 measured by the sensor 112 at the start of a time interval or evaluation window (e.g., the start temperature is measured as the SOC 102 begins to execute instructions and/or a workload).

At block 706, the example power calculator circuitry 404 determines a power usage of the SOC 102 and/or at least one of the cores 110. In this example, the power calculator circuitry 404 utilizes a voltage and drawn current of the SOC 102 to determine the power usage during the time interval.

At block 708, in some examples, the power calculator circuitry 404 determines an increase in power of the SOC 102. In this example the increase in power occurs over the aforementioned time interval.

At block 710, the power calculator circuitry 404 of the illustrated example determines a final temperature associated with the SOC 102. In this example, the final temperature corresponds to a temperature measured by the sensor 112 at an end of the time interval.

At block 712, it is determined whether additional data points are to be obtained to refine and/or re-define the calibrated second thermal model. If additional points are to be obtained (block 712) control of the process returns to block 702. Otherwise, the process ends/returns.

FIG. 8 is a flowchart representative of an example subroutine 608 of the example machine readable instructions and/or example operations 600 of FIG. 6.

At block 802, the monitoring analyzer circuitry 402 of the illustrated example selects and/or obtains data points acquired during monitoring of the SOC 102.

At block 804, the example calibrator circuitry 408 applies data (e.g., in the form of added or updated data points) to define and/or augment the second thermal model and/or a curve associated with the second thermal model, such as the examples shown and described above in connection with FIGS. 5A-5C. In this example, the curve and/or a representation of the curve (e.g., a table, an array, etc.) represents the second thermal model. In this example, the curve is to function as and/or facilitate the second thermal model to control the SOC 102.

At block 806, in some examples, the example calibrator circuitry 408 determines a fit of the aforementioned curve. In such examples, the calibrator circuitry 408 may fit an equation to the curve (e.g., the curve is approximated via a polynomial fit or a linear regression of a portion thereof).

At block 808, in some examples, the calibrator circuitry 408 determines a fit of the equation or other representation of the second thermal model relative to data points of the second thermal model. The fit may correspond to a degree to which the equation correlates to the data points of the second thermal model (e.g., similar to that of a linear regression fit value).

At block 810, it is determined by the calibrator circuitry 408 whether to repeat the process. If the process is to be repeated (block 810), control of the process proceeds to “A”, which corresponds to block 606.

FIG. 9 is a flowchart representative of an example subroutine 610 of the example machine readable instructions and/or example operations 600 of FIG. 6.

At block 902, the example publisher circuitry 410 replaces the default first thermal model with the calibrated second thermal model. In the illustrated example, the second thermal model is originally based on the first thermal model such that data points of the first thermal model have been replaced with newer data points corresponding to monitoring of the individual SOC 102 to define the second thermal model.

At block 904, in some examples, the curve associated with the second thermal model is rebuilt and/or modified by the calibrator circuitry 408. For example, data points of the second thermal model may be filtered and/or removed.

At block 906, in some examples, the curve is verified and the process of FIG. 9 ends/returns. For example, the curve may be verified to have a sufficient fit and/or include a sufficient number of data points.

FIG. 10 is a block diagram of an example processor platform 1000 structured to execute and/or instantiate the machine readable instructions and/or the operations of FIGS. 6-9 to implement the in-field calibration of FIG. 4. The processor platform 1000 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs, microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example frequency controller circuitry 401, the example monitoring analyzer circuitry 402, the example power calculator circuitry 404, the example thermal model generator circuitry 406, the example calibrator circuitry 408, and the example publisher circuitry 410.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1032, which may be implemented by the machine readable instructions of FIGS. 6-9, may be stored in the mass storage device 1028, in the volatile memory 1014, in the non-volatile memory 1016, and/or on a removable non-transitory computer readable storage medium such as a CD or DVD.

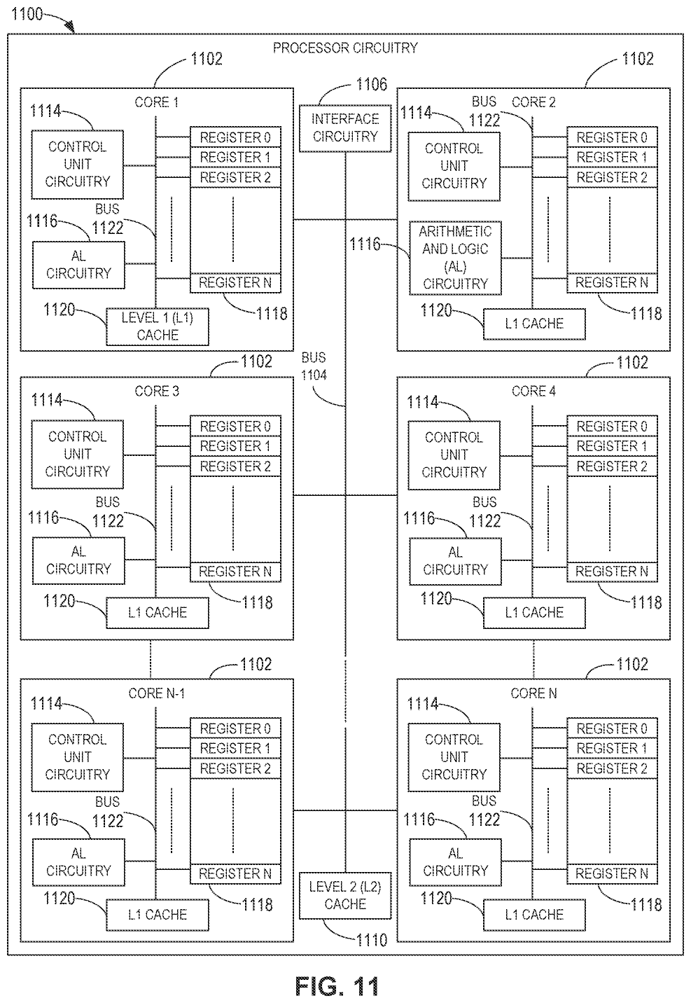

FIG. 11 is a block diagram of an example implementation of the processor circuitry 1012 of FIG. 10. In this example, the processor circuitry 1012 of FIG. 10 is implemented by a general purpose microprocessor 1100. The general purpose microprocessor circuitry 1100 executes some or all of the machine readable instructions of the flowcharts of FIGS. 6-9 to effectively instantiate the circuitry of FIG. 4 as logic circuits to perform the operations corresponding to those machine readable instructions. In some such examples, the circuitry of FIG. 4 is instantiated by the hardware circuits of the microprocessor 1100 in combination with the instructions. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 6-9.

The cores 1102 may communicate by a first example bus 1104. In some examples, the first bus 1104 may implement a communication bus to effectuate communication associated with one(s) of the cores 1102. For example, the first bus 1104 may implement at least one of an Inter-Integrated Circuit (I2C) bus, a Serial Peripheral Interface (SPI) bus, a PCI bus, or a PCIe bus. Additionally or alternatively, the first bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating point operations. In yet other examples, the AL circuitry 1116 may include first AL circuitry that performs integer based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The second bus 1122 may implement at least one of an I2C bus, a SPI bus, a PCI bus, or a PCIe bus

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

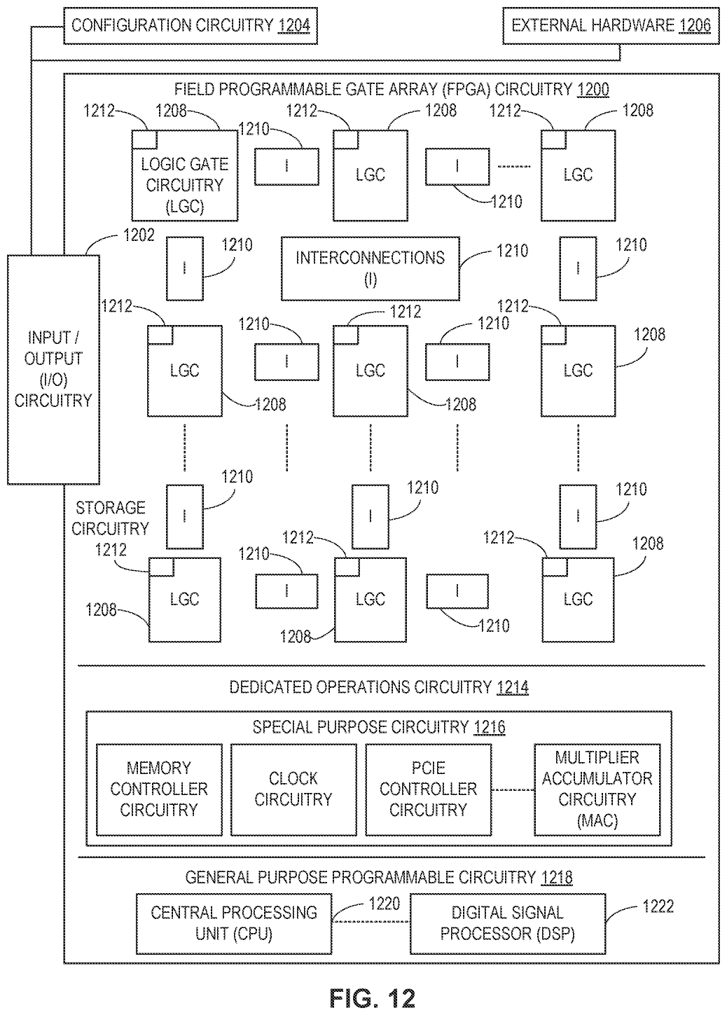

FIG. 12 is a block diagram of another example implementation of the processor circuitry 1012 of FIG. 10. In this example, the processor circuitry 1012 is implemented by FPGA circuitry 1200. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the machine readable instructions in hardware and, thus, can often execute the operations faster than they could be performed by a general purpose microprocessor executing the corresponding software.

More specifically, in contrast to the microprocessor 1100 of FIG. 11 described above (which is a general purpose device that may be programmed to execute some or all of the machine readable instructions represented by the flowcharts of FIGS. 6-9 but whose interconnections and logic circuitry are fixed once fabricated), the FPGA circuitry 1200 of the example of FIG. 12 includes interconnections and logic circuitry that may be configured and/or interconnected in different ways after fabrication to instantiate, for example, some or all of the machine readable instructions represented by the flowcharts of FIGS. 6-9. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowcharts of FIGS. 6-9. As such, the FPGA circuitry 1200 may be structured to effectively instantiate some or all of the machine readable instructions of the flowcharts of FIGS. 6-9 as dedicated logic circuits to perform the operations corresponding to those software instructions in a dedicated manner analogous to an ASIC. Therefore, the FPGA circuitry 1200 may perform the operations corresponding to the some or all of the machine readable instructions of FIGS. 6-9 faster than the general purpose microprocessor can execute the same.

In the example of FIG. 12, the FPGA circuitry 1200 is structured to be programmed (and/or reprogrammed one or more times) by an end user by a hardware description language (HDL) such as Verilog. The FPGA circuitry 1200 of FIG. 12, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 11. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine readable instructions of FIGS. 6-9 and/or other desired operations. The logic gate circuitry 1208 shown in FIG. 12 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the processor circuitry 1012 of FIG. 10, many other approaches are contemplated. For example, as mentioned above, modern FPGA circuitry may include an on-board CPU, such as one or more of the example CPU 1220 of FIG. 12. Therefore, the processor circuitry 1012 of FIG. 10 may additionally be implemented by combining the example microprocessor 1100 of FIG. 11 and the example FPGA circuitry 1200 of FIG. 12. In some such hybrid examples, a first portion of the machine readable instructions represented by the flowcharts of FIGS. 6-9 may be executed by one or more of the cores 1102 of FIG. 11, a second portion of the machine readable instructions represented by the flowcharts of FIGS. 6-9 may be executed by the FPGA circuitry 1200 of FIG. 12, and/or a third portion of the machine readable instructions represented by the flowcharts of FIGS. 6-9 may be executed by an ASIC. It should be understood that some or all of the circuitry of FIG. 4 may, thus, be instantiated at the same or different times. Some or all of the circuitry may be instantiated, for example, in one or more threads executing concurrently and/or in series. Moreover, in some examples, some or all of the circuitry of FIG. 4 may be implemented within one or more virtual machines and/or containers executing on the microprocessor.

In some examples, the processor circuitry 1012 of FIG. 10 may be in one or more packages. For example, the processor circuitry 1100 of FIG. 11 and/or the FPGA circuitry 1200 of FIG. 12 may be in one or more packages. In some examples, an XPU may be implemented by the processor circuitry 1012 of FIG. 10, which may be in one or more packages. For example, the XPU may include a CPU in one package, a DSP in another package, a GPU in yet another package, and an FPGA in still yet another package.

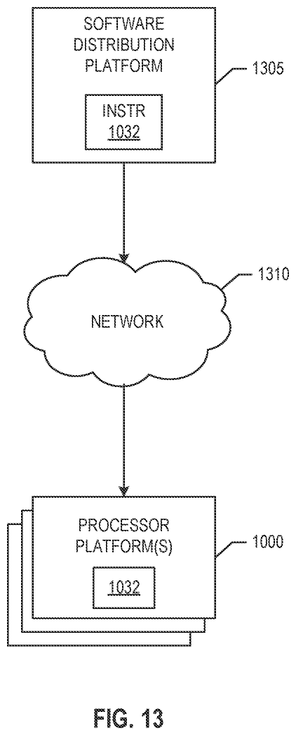

A block diagram illustrating an example software distribution platform 1305 to distribute software such as the example machine readable instructions 1032 of FIG. 10 to hardware devices owned and/or operated by third parties is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions 600, 606, 608, 610 of FIGS. 6-9, as described above. The one or more servers of the example software distribution platform 1305 are in communication with a network 1310, which may correspond to any one or more of the Internet and/or the example network 130 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions 1032 of FIG. 10, may be downloaded to the example processor platform 1000, which is to execute the machine readable instructions 1032 to implement the in-field calibration system 400. In some example, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices.

Example methods, apparatus, systems, and articles of manufacture to enable in-field thermal calibration of computing devices are disclosed herein. Further examples and combinations thereof include the following:

Example 1 includes an apparatus comprising instructions, memory in the apparatus, and processor circuitry to execute the instructions to determine that a system on chip (SOC) package is deployed, the SOC package deployed with a default first thermal model, in response to the determination that the SOC package is deployed, monitor at least one temperature of the SOC package from a sensor and power usage of the SOC package, calibrate a second thermal model based on the at least one temperature and the power usage, and publish the calibrated second thermal model for control of the SOC package.

Example 2 includes the apparatus as defined in example 1, wherein the first thermal model and the second thermal model are unitary.

Example 3 includes the apparatus as defined in example 2, wherein the processor circuitry is to execute the instructions to replace data points associated with the first thermal model with data points of the monitoring of the at least one temperature and the power usage to calibrate the second thermal model.

Example 4 includes the apparatus as defined in example 1, wherein the processor circuitry is to execute the instructions to calibrate a third thermal model after a time duration of the SOC package being deployed.

Example 5 includes the apparatus as defined in example 1, wherein the processor circuitry is to execute the instructions to determine that a requisite number of data points pertaining to the at least one temperature and the power usage have been obtained while monitoring thereof, and in response to determining that the requisite number of the data points have been obtained, initiate the calibration of the second thermal model.

Example 6 includes the apparatus as defined in example 1, wherein the sensor includes an on-die temperature sensor of the SOC package.

Example 7 includes the apparatus as defined in example 1, wherein the processor circuitry is to cause at least one core of the SOC package to execute a pre-defined workload to calibrate the second thermal model.

Example 8 includes the apparatus as defined in example 1, wherein the processor circuitry is to execute the instructions to cause the SOC package to operate based on the first thermal model until the second thermal model is calibrated.

Example 9 includes the apparatus as defined in example 1, wherein the processor circuitry is to execute the instructions to calculate the power usage based on current drawn by the SOC package along with a voltage associated with the SOC package.

Example 10 includes the apparatus as defined in example 1, wherein the processor circuitry is to execute the instructions to calibrate the second thermal model while the SOC package is operated with routine workloads associated with deployment thereof.

Example 11 includes a non-transitory computer readable medium comprising instructions which, when executed, cause at least one processor to determine that a system on chip (SOC) package is deployed, the SOC package deployed with a default first thermal model, in response to the determination that the SOC package is deployed, monitor at least one temperature of the SOC package from a sensor and power usage of the SOC package, calibrate a second thermal model based on the at least one temperature and the power usage, and publish the calibrated second thermal model for control of the SOC package.

Example 12 includes the non-transitory computer readable medium as defined in example 11, wherein the first thermal model and the second thermal model are unitary.

Example 13 includes the non-transitory computer readable medium as defined in example 12, wherein the instructions cause the at least one processor to replace data points associated with the first thermal model with data points from the monitoring of the at least one temperature and the power usage to calibrate the second thermal model.

Example 14 includes the non-transitory computer readable medium as defined in example 11, wherein the instructions cause the at least one processor to execute the instructions to calibrate a third thermal model after a time duration of the SOC package being deployed.

Example 15 includes the non-transitory computer readable medium as defined in example 11, wherein the instructions cause the at least one processor to determine that a requisite number of data points pertaining to the at least one temperature and the power usage have been obtained while monitoring thereof, and in response to determining that the requisite number of the data points have been obtained, initiate the calibration of the second thermal model.

Example 16 includes the non-transitory computer readable medium as defined in example 11, wherein the instructions cause the at least one processor to direct at least one core of the SOC package to execute a pre-defined workload to calibrate the second thermal model.

Example 17 includes the non-transitory computer readable medium as defined in example 11, wherein the instructions cause the at least one processor to direct the SOC package to operate based on the first thermal model until the second thermal model is calibrated.

Example 18 includes the non-transitory computer readable medium as defined in example 11, wherein the instructions cause the at least one processor to fit an equation to the second thermal model.

Example 19 includes the non-transitory computer readable medium as defined in example 11, wherein the instructions cause the at least one processor to calculate the power usage based on current drawn by the SOC package along with a voltage associated with the SOC package.

Example 20 includes the non-transitory computer readable medium as defined in example 11, wherein the instructions cause the at least one processor to calibrate the second thermal model while the SOC package is operated with routine workloads associated with deployment thereof.

Example 21 includes a method comprising determining, by executing instructions with at least one processor, that a system on chip (SOC) package is deployed, the SOC package deployed with a default first thermal model, in response to the determining that the SOC package is deployed, monitoring, by executing instructions with the at least one processor, at least one temperature of the SOC package from a sensor and power usage of the SOC package, calibrating, by executing instructions with the at least one processor, a second thermal model based on the at least one temperature and the power usage, and publishing, by executing instructions with the at least one processor, the calibrated second thermal model for control of the SOC package.

Example 22 includes the method as defined in example 21, wherein the first thermal model and the second thermal model are unitary.

Example 23 includes the method as defined in example 22, further including replacing, by executing instructions with the at least one processor, data points associated with the first thermal model with data points from the monitoring of the at least one temperature and the power usage to calibrate the second thermal model.

Example 24 includes the method as defined in example 21, further including calibrating, by executing instructions with the at least one processor, a third thermal model after a time duration of the SOC package being deployed.

Example 25 includes the method as defined in example 21, further including determining, by executing instructions with the at least one processor, that a requisite number of data points pertaining to the at least one temperature and the power usage have been obtained while monitoring thereof, and in response to the determining that the requisite number of data points have been obtained, initiating, by executing instructions with the at least one processor, the calibration of the second thermal model.

Example 26 includes the method as defined in example 21, further including directing, by executing instructions with the at least one processor, at least one core of the SOC package to execute an identified workload to calibrate the second thermal model.

Example 27 includes the method as defined in example 21, further including directing, by executing instructions with the at least one processor, the SOC package to operate based on the first thermal model until the second thermal model is calibrated.

Example 28 includes the method as defined in example 21, further including fitting, by executing instructions with the at least one processor, an equation to the second thermal model.

Example 29 includes the method as defined in example 21, further including calculating, by executing instructions with the at least one processor, the power usage based on current drawn by the SOC package along with a voltage associated with the SOC package.

From the foregoing, it will be appreciated that example systems, methods, apparatus, and articles of manufacture have been disclosed that enable accurate control of computing devices and enable utilization of a full capability of the computing device. Examples disclosed herein personalize a thermal guard band used by SOCs to prevent violation of design limits. According to examples disclosed herein, a thermal guard band can be optimized according to individual characteristics of a system to utilize a greater potential of the system. In some initial testing, a 1-2% performance improvement was observed in contrast to a known one-size-fits-all approach. Examples disclosed herein have been demonstrated to proactively reduce frequency when a measured temperature rose to within 5° C. of a limit. Examples disclosed herein recover a significant portion of this performance loss by enabling prediction of when the temperature will overshoot tailoring specific temperature prediction to the actual system.

Disclosed systems, methods, apparatus, and articles of manufacture improve the efficiency of using a computing device by enabling increased utilization thereof and, thus, enabling quicker completion of computing tasks based on available thermal overhead. Disclosed systems, methods, apparatus, and articles of manufacture are accordingly directed to one or more improvement(s) in the operation of a machine such as a computer or other electronic and/or mechanical device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
instructions;
memory in the apparatus; and
processor circuitry to execute the instructions to:
determine that a system on chip (SOC) package is deployed, the SOC package deployed with a default first thermal model,
in response to the determination that the SOC package is deployed, monitor at least one temperature of the SOC package from a sensor and power usage of the SOC package,
calibrate a second thermal model based on the at least one temperature and the power usage, and
publish the calibrated second thermal model for control of the SOC package.

2. The apparatus as defined in claim 1, wherein the first thermal model and the second thermal model are unitary.

3. The apparatus as defined in claim 2, wherein the processor circuitry is to execute the instructions to replace data points associated with the first thermal model with data points of the monitoring of the at least one temperature and the power usage to calibrate the second thermal model.

4. The apparatus as defined in claim 1, wherein the processor circuitry is to execute the instructions to calibrate a third thermal model after a time duration of the SOC package being deployed.

5. The apparatus as defined in claim 1, wherein the processor circuitry is to execute the instructions to:
determine that a requisite number of data points pertaining to the at least one temperature and the power usage have been obtained while monitoring thereof, and
in response to determining that the requisite number of the data points have been obtained, initiate the calibration of the second thermal model.

6. The apparatus as defined in claim 1, wherein the sensor includes an on-die temperature sensor of the SOC package.

7. The apparatus as defined in claim 1, wherein the processor circuitry is to cause at least one core of the SOC package to execute a pre-defined workload to calibrate the second thermal model.

8. The apparatus as defined in claim 1, wherein the processor circuitry is to execute the instructions to cause the SOC package to operate based on the first thermal model until the second thermal model is calibrated.

9. The apparatus as defined in claim 1, wherein the processor circuitry is to execute the instructions to calculate the power usage based on current drawn by the SOC package along with a voltage associated with the SOC package.

10. The apparatus as defined in claim 1, wherein the processor circuitry is to execute the instructions to calibrate the second thermal model while the SOC package is operated with routine workloads associated with deployment thereof.

11. A non-transitory computer readable medium comprising instructions which, when executed, cause at least one processor to:
determine that a system on chip (SOC) package is deployed, the SOC package deployed with a default first thermal model;
in response to the determination that the SOC package is deployed, monitor at least one temperature of the SOC package from a sensor and power usage of the SOC package;
calibrate a second thermal model based on the at least one temperature and the power usage; and
publish the calibrated second thermal model for control of the SOC package.

12. The non-transitory computer readable medium as defined in claim 11, wherein the first thermal model and the second thermal model are unitary.

13. The non-transitory computer readable medium as defined in claim 12, wherein the instructions cause the at least one processor to replace data points associated with the first thermal model with data points from the monitoring of the at least one temperature and the power usage to calibrate the second thermal model.

14. The non-transitory computer readable medium as defined in claim 11, wherein the instructions cause the at least one processor to execute the instructions to calibrate a third thermal model after a time duration of the SOC package being deployed.

15. The non-transitory computer readable medium as defined in claim 11, wherein the instructions cause the at least one processor to:
determine that a requisite number of data points pertaining to the at least one temperature and the power usage have been obtained while monitoring thereof, and
in response to determining that the requisite number of the data points have been obtained, initiate the calibration of the second thermal model.

16. The non-transitory computer readable medium as defined in claim 11, wherein the instructions cause the at least one processor to direct at least one core of the SOC package to execute a pre-defined workload to calibrate the second thermal model.

17. The non-transitory computer readable medium as defined in claim 11, wherein the instructions cause the at least one processor to direct the SOC package to operate based on the first thermal model until the second thermal model is calibrated.

18. The non-transitory computer readable medium as defined in claim 11, wherein the instructions cause the at least one processor to fit an equation to the second thermal model.

19. The non-transitory computer readable medium as defined in claim 11, wherein the instructions cause the at least one processor to calculate the power usage based on current drawn by the SOC package along with a voltage associated with the SOC package.

20. The non-transitory computer readable medium as defined in claim 11, wherein the instructions cause the at least one processor to calibrate the second thermal model while the SOC package is operated with routine workloads associated with deployment thereof.

21. A method comprising
determining, by executing instructions with at least one processor, that a system on chip (SOC) package is deployed, the SOC package deployed with a default first thermal model;
in response to the determining that the SOC package is deployed, monitoring, by executing instructions with the at least one processor, at least one temperature of the SOC package from a sensor and power usage of the SOC package;
calibrating, by executing instructions with the at least one processor, a second thermal model based on the at least one temperature and the power usage; and
publishing, by executing instructions with the at least one processor, the calibrated second thermal model for control of the SOC package.

22. The method as defined in claim 21, wherein the first thermal model and the second thermal model are unitary.

23. The method as defined in claim 22, further including replacing, by executing instructions with the at least one processor, data points associated with the first thermal model with data points from the monitoring of the at least one temperature and the power usage to calibrate the second thermal model.

24. The method as defined in claim 21, further including calibrating, by executing instructions with the at least one processor, a third thermal model after a time duration of the SOC package being deployed.

25. The method as defined in claim 21, further including:
determining, by executing instructions with the at least one processor, that a requisite number of data points pertaining to the at least one temperature and the power usage have been obtained while monitoring thereof, and
in response to the determining that the requisite number of data points have been obtained, initiating, by executing instructions with the at least one processor, the calibration of the second thermal model.

26. The method as defined in claim 21, further including directing, by executing instructions with the at least one processor, at least one core of the SOC package to execute an identified workload to calibrate the second thermal model.

27. The method as defined in claim 21, further including directing, by executing instructions with the at least one processor, the SOC package to operate based on the first thermal model until the second thermal model is calibrated.

28. The method as defined in claim 21, further including fitting, by executing instructions with the at least one processor, an equation to the second thermal model.

29. The method as defined in claim 21, further including calculating, by executing instructions with the at least one processor, the power usage based on current drawn by the SOC package along with a voltage associated with the SOC package.
